(19) United States
(12) Patent Application Publication
(10) Pub. No.: US 2004/0249637 A1
(43) Pub. Date: Dec. 9, 2004

(54) Detecting repeated phrases and inference of dialogue models

(75) Inventor: James K. Baker, Maitland, FL (US)

Correspondence Address: FOLEY AND LARDNER, SUITE 500, 3000 K STREET NW, WASHINGTON, DC, 20007, US

(73) Assignee: Aurilab, LLC

(21) Appl. No.: 10/857,896

(22) Filed: Jun. 2, 2004

Related U.S. Application Data
(60) Provisional application No. 60/475,502, filed on Jun. 4, 2003.
(60) Provisional application No. 60/563,290, filed on Apr. 19, 2004.

(51) Int. Cl. G10L 15/00

(52) U.S. Cl. 704/239

(57) ABSTRACT

A method of speech recognition obtains acoustic data from a plurality of conversations. A plurality of pairs of utterances are selected from the plurality of conversations. At least one portion of the first utterance of the pair of utterances is dynamically aligned with at least one portion of the second utterance of the pair of utterance, and an acoustic similarity is computed. At least one pair that includes a first portion from a first utterance and a second portion from a second utterance is chosen, based on a criterion of acoustic similarity. A common pattern template is created from the first portion and the second portion.

### RELATED APPLICATIONS

This application claims priority to U.S. Provisional Patent Application 60/475,502, filed Jun. 4, 2003, and U.S. Provisional Patent Application 60/563,290, filed Apr. 19, 2004, both of which are incorporated in their entirety herein by reference.

### DESCRIPTION OF THE RELATED ART

Computers have become a significant aid to communications. When people are exchanging text or digital data, computers can even analyze the data and perhaps participate in the content of the communication. For computers to perceive the content of spoken communications, however, requires a speech recognition process. High performance speech recognition in turn requires training to adapt it to the speech and language usage of a user or group of users and perhaps to the special language usage of a given application.

There are a number of applications in which a large amount of recorded speech is available. For example, a large call center may record thousands of hours of speech in a single day. However, generally these calls are only recorded, not transcribed. To transcribe this quantity of speech recordings just for the purpose of speech recognition training would be prohibitively expensive.

On the other hand, for call centers and other applications in which there is a large quantity of recorded speech, the conversations are often highly constrained by the limited nature of the particular interaction and the conversations are also often highly repetitive from one conversation to another.

Accordingly, the present inventor has determined that there is a need to detect repetitive portions of speech and utilize this information in the speech recognition training process. There is also a need to achieve more accurate recognition based on the detection of repetitive portions of speech. There is also a need to facilitate the transcription process and greatly reduce the expense of transcription of repetitive material. There is also a need to allow training of the speech recognition system for some applications without requiring transcriptions at all.

The present invention is directed to overcoming or at least reducing the effects of one or more of the needs set forth above.

### SUMMARY OF THE INVENTION

According to one aspect of the invention, there is provided a method of speech recognition, which includes obtaining acoustic data from a plurality of conversations. The method also includes selecting a plurality of pairs of utterances from said plurality of conversations. The method further includes dynamically aligning and computing acoustic similarity of at least one portion of the first utterance of said pair of utterances with at least one portion of the second utterance of said pair of utterances. The method also includes choosing at least one pair that includes a first portion from a first utterance and a second portion from a second utterance based on a criterion of acoustic similarity. The method still further includes creating a common pattern template from the first portion and the second portion.

According to another aspect of the invention, there is provided a speech recognition grammar inference system, which includes means for obtaining word scripts for utterances from a plurality of conversations based at least in part on a speech recognition process. The system also includes means for counting a number of times that each word sequence occurs in the said word scripts. The system further includes means for creating a set of common word sequences based on the frequency of occurrence of each word sequence. The system still further includes means for selecting a set of sample phrases from said word scripts including a plurality of word sequences from said set of common word sequences. The system also includes means for creating a plurality of phrase templates from said set of samples phrases by using said fixed template portions to represent said common word sequences and variable template portions to represent other word sequences in said set of sample phrases.

According to yet another aspect of the invention, there is provided a program product having machine-readable program code for performing speech recognition, the program code, when executed, causing a machine to: a) obtain word script for utterances from a plurality of conversations based at least in part on a speech recognition process; b) represent the process of each speaker speaking in turn in a given conversation as a sequence of hidden random variables; c) represent the probability of occurrence of words and common word sequences as based on the values of the sequence of hidden random variables; and d) infer the probability distributions of the hidden random variables for each word script.

### BRIEF DESCRIPTION OF THE DRAWINGS

The foregoing advantages and features of the invention will become apparent upon reference to the following detailed description and the accompanying drawings, of which:

FIG. 1 is a flow chart showing a process of training hidden semantic dialogue models from multiple conversations with repeated common phrases, according to at least one embodiment of the invention;

FIG. 2 is a flow chart showing the creation of common pattern templates, according to at least one embodiment of the invention; and

FIG. 3 is a flow chart showing the creation of common pattern templates from more than two instances, according to at least one embodiment of the invention;

FIG. 4 is a flow chart showing word sequence recognition on a set of acoustically similar utterance portions, according to at least one embodiment of the invention;

FIG. 5 is a flow chart showing how remaining speech portions are recognized, according to at least one embodiment of the invention;

FIG. 6 is a flow chart showing how multiple transcripts can be efficiently obtained, according to at least one embodiment of the invention;

FIG. 7 is a flow chart showing how phrase templates can be created, according to at least one embodiment of the invention;

FIG. 8 is a flow chart showing how inferences can be obtained from a dialogue state space model, according to at least one embodiment of the invention;

FIG. 9 is a flow chart showing how a finite dialogue state space model can be inferred, according to at least one embodiment of the invention; and

FIG. 10 is a flow chart showing self-supervision training of recognition units and language models, according to at least one embodiment of the invention.

### DETAILED DESCRIPTION OF SPECIFIC EMBODIMENTS

The invention is described below with reference to drawings. These drawings illustrate certain details of specific embodiments that implement the systems and methods and programs of the present invention. However, describing the invention with drawings should not be construed as imposing, on the invention, any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising computer-readable media for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above are also be included within the scope of computer-readable media. Computer-executable instructions comprise, for example, instructions and data which cause a general purpose computer, special purpose computer, or special purpose processing device to perform a certain function or group of functions.

The invention will be described in the general context of method steps which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention in some embodiments, may be operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a conventional computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to removable optical disk such as a CD-ROM or other optical media. The drives and their associated computer-readable media provide nonvolatile storage of computer-executable instructions, data structures, program modules and other data for the computer.

The following terms may be used in the description of the invention and include new terms and terms that are given special meanings.

“Linguistic element” is a unit of written or spoken language.

“Speech element” is an interval of speech with an associated name. The name may be the word, syllable or phoneme being spoken during the interval of speech, or may be an abstract symbol such as an automatically generated phonetic symbol that represents the system's labeling of the sound that is heard during the speech interval.

“Priority queue” in a search system is a list (the queue) of hypotheses rank ordered by some criterion (the priority). In a speech recognition search, each hypothesis is a sequence of speech elements or a combination of such sequences for different portions of the total interval of speech being analyzed. The priority criterion may be a score which estimates how well the hypothesis matches a set of observations, or it may be an estimate of the time at which the sequence of speech elements begins or ends, or any other measurable property of each hypothesis that is useful in guiding the search through the space of possible hypotheses. A priority queue may be used by a stack decoder or by a branch-and-bound type search system. A search based on a priority queue typically will choose one or more hypotheses, from among those on the queue, to be extended. Typically each chosen hypothesis will be extended by one speech element. Depending on the priority criterion, a priority queue can implement either a best-first search or a breadth-first search or an intermediate search strategy.

“Frame” for purposes of this invention is a fixed or variable unit of time which is the shortest time unit analyzed by a given system or subsystem. A frame may be a fixed unit, such as 10 milliseconds in a system which performs spectral signal processing once every 10 milliseconds, or it may be a data dependent variable unit such as an estimated pitch period or the interval that a phoneme recognizer has associated with a particular recognized phoneme or phonetic segment. Note that, contrary to prior art systems, the use of the word “frame” does not imply that the time unit is a fixed interval or that the same frames are used in all subsystems of a given system.

“Frame synchronous beam search” is a search method which proceeds frame-by-frame. Each active hypothesis is evaluated for a particular frame before proceeding to the next frame. The frames may be processed either forwards in time or backwards. Periodically, usually once per frame, the evaluated hypotheses are compared with some acceptance criterion. Only those hypotheses with evaluations better than some threshold are kept active. The beam consists of the set of active hypotheses.

“Stack decoder” is a search system that uses a priority queue. A stack decoder may be used to implement a best first search. The term stack decoder also refers to a system implemented with multiple priority queues, such as a multi-stack decoder with a separate priority queue for each frame, based on the estimated ending frame of each hypothesis. Such a multi-stack decoder is equivalent to a stack decoder with a single priority queue in which the priority queue is sorted first by ending time of each hypothesis and then sorted by score only as a tie-breaker for hypotheses that end at the same time. Thus a stack decoder may implement either a best first search or a search that is more nearly breadth first and that is similar to the frame synchronous beam search.

“Score” is a numerical evaluation of how well a given hypothesis matches some set of observations. Depending on the conventions in a particular implementation, better matches might be represented by higher scores (such as with probabilities or logarithms of probabilities) or by lower scores (such as with negative log probabilities or spectral distances). Scores may be either positive or negative. The score may also include a measure of the relative likelihood of the sequence of linguistic elements associated with the given hypothesis, such as the a priori probability of the word sequence in a sentence.

“Dynamic programming match scoring” is a process of computing the degree of match between a network or a sequence of models and a sequence of acoustic observations by using dynamic programming. The dynamic programming match process may also be used to match or time-align two sequences of acoustic observations or to match two models or networks. The dynamic programming computation can be used for example to find the best scoring path through a network or to find the sum of the probabilities of all the paths through the network. The prior usage of the term “dynamic programming” varies. It is sometimes used specifically to mean a “best path match” but its usage for purposes of this patent covers the broader class of related computational methods, including “best path match,” “sum of paths” match and approximations thereto. A time alignment of the model to the sequence of acoustic observations is generally available as a side effect of the dynamic programming computation of the match score. Dynamic programming may also be used to compute the degree of match between two models or networks (rather than between a model and a sequence of observations). Given a distance measure that is not based on a set of models, such as spectral distance, dynamic programming may also be used to match and directly time-align two instances of speech elements.

“Best path match” is a process of computing the match between a network and a sequence of acoustic observations in which, at each node at each point in the acoustic sequence, the cumulative score for the node is based on choosing the best path for getting to that node at that point in the acoustic sequence. In some examples, the best path scores are computed by a version of dynamic programming sometimes called the Viterbi algorithm from its use in decoding convolutional codes. It may also be called the Dykstra algorithm or the Bellman algorithm from independent earlier work on the general best scoring path problem.

“Sum of paths match” is a process of computing a match between a network or a sequence of models and a sequence of acoustic observations in which, at each node at each point in the acoustic sequence, the cumulative score for the node is based on adding the probabilities of all the paths that lead to that node at that point in the acoustic sequence. The sum of paths scores in some examples may be computed by a dynamic programming computation that is sometimes called the forward-backward algorithm (actually, only the forward pass is needed for computing the match score) because it is used as the forward pass in training hidden Markov models with the Baum-Welch algorithm.

“Hypothesis” is a hypothetical proposition partially or completely specifying the values for some set of speech elements. Thus, a hypothesis is typically a sequence or a combination of sequences of speech elements. Corresponding to any hypothesis is a sequence of models that represent the speech elements. Thus, a match score for any hypothesis against a given set of acoustic observations, in some embodiments, is actually a match score for the concatenation of the models for the speech elements in the hypothesis.

“Look-ahead” is the use of information from a new interval of speech that has not yet been explicitly included in the evaluation of a hypothesis. Such information is available during a search process if the search process is delayed relative to the speech signal or in later passes of multi-pass recognition. Look-ahead information can be used, for example, to better estimate how well the continuations of a particular hypothesis are expected to match against the observations in the new interval of speech. Look-ahead information may be used for at least two distinct purposes. One use of look-ahead information is for making a better comparison between hypotheses in deciding whether to prune the poorer scoring hypothesis. For this purpose, the hypotheses being compared might be of the same length and this form of look-ahead information could even be used in a frame-synchronous beam search. A different use of look-ahead information is for making a better comparison between hypotheses in sorting a priority queue. When the two hypotheses are of different length (that is, they have been matched against a different number of acoustic observations), the look-ahead information is also referred to as missing piece evaluation since it estimates the score for the interval of acoustic observations that have not been matched for the shorter hypothesis.

“Sentence” is an interval of speech or a sequence of speech elements that is treated as a complete unit for search or hypothesis evaluation. Generally, the speech will be broken into sentence length units using an acoustic criterion such as an interval of silence. However, a sentence may contain internal intervals of silence and, on the other hand, the speech may be broken into sentence units due to grammatical criteria even when there is no interval of silence. The term sentence is also used to refer to the complete unit for search or hypothesis evaluation in situations in which the speech may not have the grammatical form of a sentence, such as a database entry, or in which a system is analyzing as a complete unit an element, such as a phrase, that is shorter than a conventional sentence.

“Phoneme” is a single unit of sound in spoken language, roughly corresponding to a letter in written language.

“Phonetic label” is the label generated by a speech recognition system indicating the recognition system's choice as to the sound occurring during a particular speech interval. Often the alphabet of potential phonetic labels is chosen to be the same as the alphabet of phonemes, but there is no requirement that they be the same. Some systems may distinguish between phonemes or phonemic labels on the one hand and phones or phonetic labels on the other hand. Strictly speaking, a phoneme is a linguistic abstraction. The sound labels that represent how a word is supposed to be pronounced, such as those taken from a dictionary, are phonemic labels. The sound labels that represent how a particular instance of a word is spoken by a particular speaker are phonetic labels. The two concepts, however, are intermixed and some systems make no distinction between them.

“Spotting” is the process of detecting an instance of a speech element or sequence of speech elements by directly detecting an instance of a good match between the model(s) for the speech element(s) and the acoustic observations in an interval of speech without necessarily first recognizing one or more of the adjacent speech elements.

“Training” is the process of estimating the parameters or sufficient statistics of a model from a set of samples in which the identities of the elements are known or are assumed to be known. In supervised training of acoustic models, a transcript of the sequence of speech elements is known, or the speaker has read from a known script. In unsupervised training, there is no known script or transcript other than that available from unverified recognition. In one form of semi-supervised training, a user may not have explicitly verified a transcript but may have done so implicitly by not making any error corrections when an opportunity to do so was provided.

“Acoustic model” is a model for generating a sequence of acoustic observations, given a sequence of speech elements. The acoustic model, for example, may be a model of a hidden stochastic process. The hidden stochastic process would generate a sequence of speech elements and for each speech element would generate a sequence of zero or more acoustic observations. The acoustic observations may be either (continuous) physical measurements derived from the acoustic waveform, such as amplitude as a function of frequency and time, or may be observations of a discrete finite set of labels, such as produced by a vector quantizer as used in speech compression or the output of a phonetic recognizer. The continuous physical measurements would generally be modeled by some form of parametric probability distribution such as a Gaussian distribution or a mixture of Gaussian distributions. Each Gaussian distribution would be characterized by the mean of each observation measurement and the covariance matrix. If the covariance matrix is assumed to be diagonal, then the multi-variant Gaussian distribution would be characterized by the mean and the variance of each of the observation measurements. The observations from a finite set of labels would generally be modeled as a non-parametric discrete probability distribution. However, other forms of acoustic models could be used. For example, match scores could be computed using neural networks, which might or might not be trained to approximate a posteriori probability estimates. Alternately, spectral distance measurements could be used without an underlying probability model, or fuzzy logic could be used rather than probability estimates.

“Grammar” is a formal specification of which word sequences or sentences are legal (or grammatical) word sequences. There are many ways to implement a grammar specification. One way to specify a grammar is by means of a set of rewrite rules of a form familiar to linguistics and to writers of compilers for computer languages. Another way to specify a grammar is as a state-space or network. For each state in the state-space or node in the network, only certain words or linguistic elements are allowed to be the next linguistic element in the sequence. For each such word or linguistic element, there is a specification (say by a labeled arc in the network) as to what the state of the system will be at the end of that next word (say by following the arc to the node at the end of the arc). A third form of grammar representation is as a database of all legal sentences.

“Stochastic grammar” is a grammar that also includes a model of the probability of each legal sequence of linguistic elements.

“Pure statistical language model” is a statistical language model that has no grammatical component. In a pure statistical language model, generally every possible sequence of linguistic elements will have a non-zero probability.

The present invention is directed to automatically constructing dialogue grammars for a call center. According to a first embodiment of the invention, dialogue grammars are constructed by way of the following process:

a) Detect repeated phrases from acoustics alone (DTW alignment);

b) Recognize words using the multiple instances to lower error rate;

c) Optionally use human transcriptionists to do error correct on samples of the repeated phrases (lower cost because they only have to do a one instance among many);

d) Infer grammar from transcripts;

e) Infer dialog;

f) Infer semantics from similar dialog states in multiple conversations.

To better understand the process, consider an example application in a large call center. The intended applications in this example include applications in which a user is trying to get information, place an order, or make a reservation over the telephone. Over the course of time, many callers will have the same or similar questions or tasks and will tend to use the same phrases as other callers. Consider as one example, a call center that is handling mail order sales for a company with large mail-order catalog. As a second example, consider an automated personal assistant which retrieves e-mail, records responses, displays an appointment calendar, and schedules meetings.

Some of the phrases that might be repeated many times to a mail order call center operator include:

a) “I would like to place and order.”

b) “I would like information about . . . ” (description of a particular product)

c) “What is the price of . . . ?”

d) “Do you have any . . . ?”

e) “What colors do you have?”

f) “What is the shipping cost?”

g) “Do you have any in stock?”

A single call center operator might hear these phrases hundreds of times per day. In the course of a month, a large call center might record some of these phrases hundreds of thousands or even millions of times.

If transcripts were available for all of the calls, the information from these transcripts could be used to improve the performance of speech recognition, which could then be used to improve the efficiency and quality of the call handling. On the other hand, the large volume of calls placed to a typical call center would make it prohibitively expensive to transcribe all of the calls using human transcriptionists. Hence it is desirable also to use speech recognition as an aid in getting the transcriptions that might in turn improve the performance of the speech recognition.

There is a problem, however, because recognition of conversational speech over the telephone is a difficult task. In particular, the initial speech recognition, which must be performed without the knowledge that will be obtained from the transcripts may have too many errors to be useful. For example, beyond a certain error rate, it is more difficult (and more expensive) for a transcriptionist to correct the errors of a speech recognizer than simply to transcribe the speech from scratch.

The following are automated personal assistant example sentences:

a) “Look up . . . ” (name in personal phonebook)

b) “Get me the number of . . . ” (name in personal phonebook)

c) “Display e-mail list”

d) “Get e-mail”

e) “Get my e-mail”

f) “Get today's e-mail”

g) “Display today's e-mail”

h) “Display calendar for . . . ” (date)

i) “Go to . . . ” (date)

j) “Get appointments for next Tuesday”

k) “Show calendar for May 6, 2003”

l) “Schedule a meeting with . . . (name) on . . . (date)”

m) “Send a message to . . . (name) about a meeting on . . . (date)”

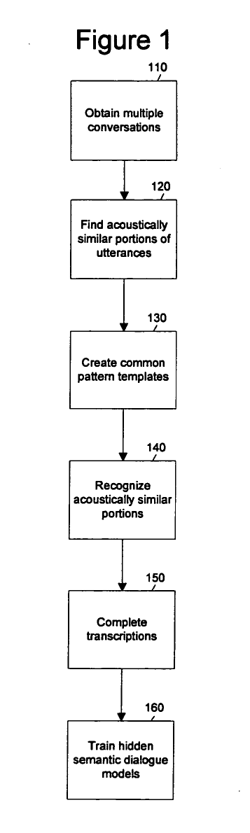

The present invention according to at least one embodiment eliminates or reduces these problems by utilizing the repetitive nature of the calls without first requiring a transcript. A first embodiment of the present invention will be described below with respect to FIG. 1, which describes processing of multiple conversations with repeated common phrases, in order to train hidden semantic dialogue models. To enable this process, block 110 obtains acoustic data from a sufficient number of calls (or more generally conversations, whether over the telephone or not) so that a number of commonly occurring phrases will have occurred multiple times in the sample of acoustic data. The present invention according to the first embodiment utilizes the fact that phrases are repeated (without yet knowing what the phrases are).

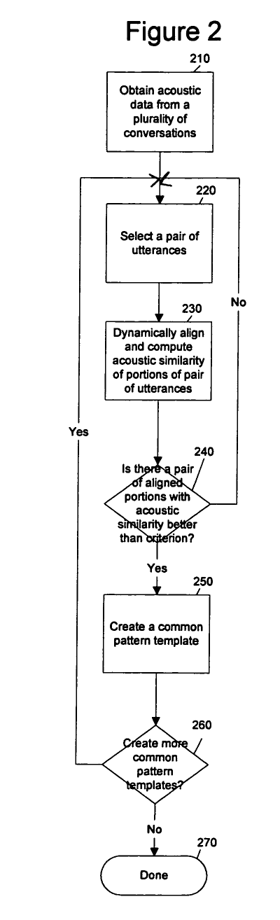

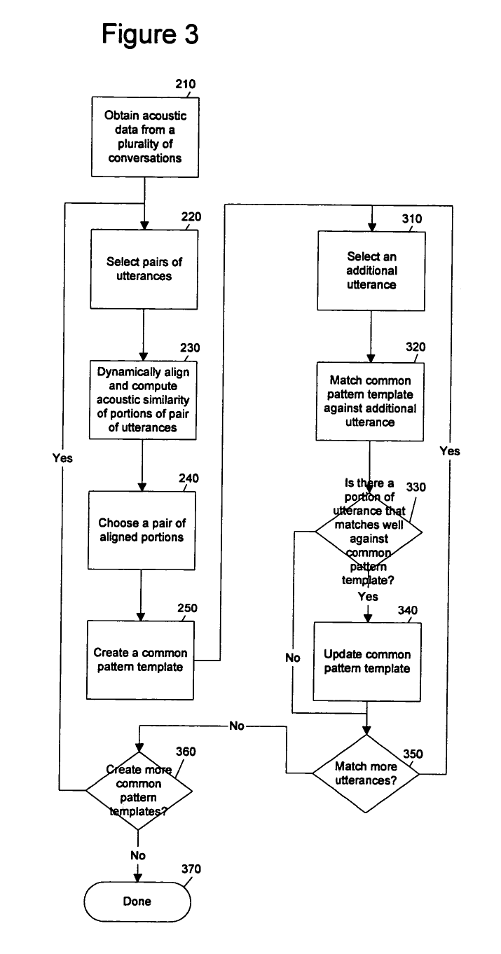

Block 120 finds acoustically similar portions of utterances, as will be explained in more detail in reference to FIG. 2. As explained in detail in FIG. 2 and FIG. 3, utterances are compared to find acoustically similar portions even without knowing what words are being spoken or having acoustic models for the words. Using the processes shown in FIG. 2 and FIG. 3, common pattern templates are created.

Turning back to FIG. 1, Block 130 creates templates or models for the repeated acoustically similar portions of utterances.

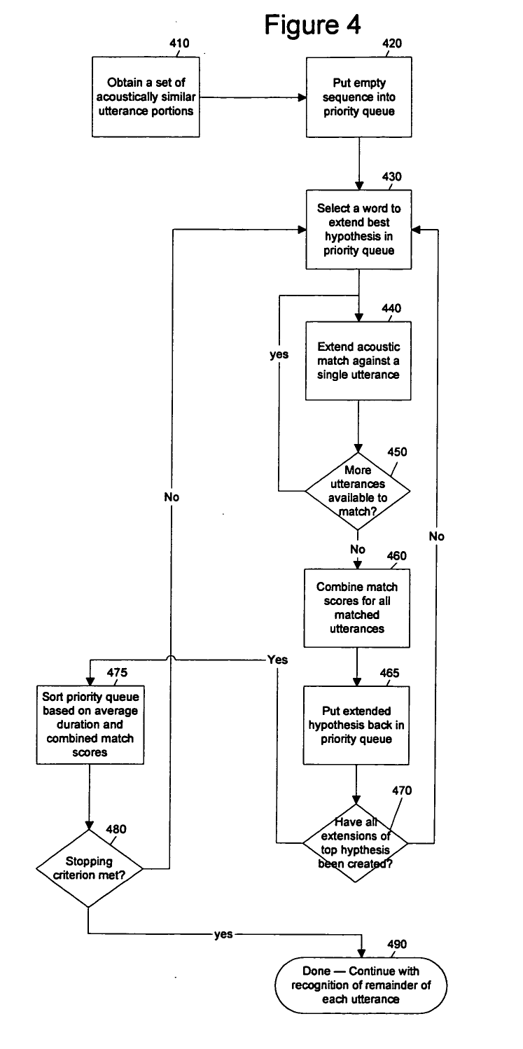

Block 140 recognizes the word sequences in the repeated acoustically similar phrases. As explained with reference to FIG. 4, having multiple instances of the same word or phrase permit more reliable and less errorful recognition of the word or phrase, by performing word sequence recognition on a set of acoustically similar utterance portions.

Turning back to FIG. 1, Block 150 completes the transcriptions of the conversations using human transcriptionists or by automatic speech recognition using the recognized common phrases or partial human transcriptions as context for recognizing the remaining words.

With the obtained transcripts, Block 160 trains hidden stochastic models for the collection of conversations. In one implementation of the first embodiment, the collection of conversations being analyzed all have a common subject and purpose.

Each conversation will often be a dialogue between two people to accomplish a specific purpose. By way of example and not by way of limitation, all of the conversations in a given collection may be dialogues between customers of a particular company and customer support personnel. In this example, one speaker in each conversation is a customer and one speaker is a company representative. The purpose of the conversation in this example is to give information to the customer or to help the customer with a problem. The subject matter of all the conversations is the company's products and their features and attributes.

Alternatively, the “conversation” may be between a user and an automated system. In the description of the first embodiment provided herein, there is only one human speaker. In one implementation of this embodiment, the automated system may be operated over the telephone using an automated voice response system, so the “conversation” will be a “dialogue” between the user and the automated system. In another implementation of this embodiment, the automated system may be a handheld or desktop unit that displays its responses on a display device, so the “conversation” will include spoken commands and questions from the user and graphically displayed responses from the automated system.

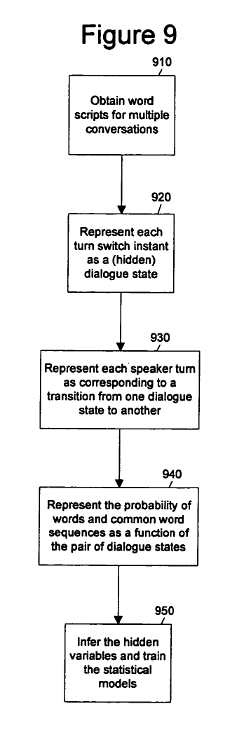

Block 160 trains a hidden stochastic model that is designed to capture the nature and structure of the dialogue, given the particular task that the participants are trying to accomplish and to capture some of the semantic information that corresponds to particular states through which each dialogue progresses. This process will be explained in more detail in reference to FIG. 9.

Referring to FIG. 2, block 210 obtains acoustic data from a plurality of conversations. A plurality of conversations is analyzed in order to find the common phrases that are repeated in multiple conversations.

Block 220 selects a pair of utterances. The process of finding repeated phrases begins by comparing a pair of utterances at a time.

Block 230 dynamically aligns the pair of utterances to find the best non-linear warping of the time axis of one of the utterances to align a portion of each utterance with a portion of the other utterance to get the best match of the aligned acoustic data. In one implementation of the first embodiment, this alignment is performed by a variant of the well-known technique of dynamic-time-warping. In simple dynamic-time-warping, the acoustic data of one word instance spoken in isolation is aligned with another word instance spoken in isolation. The technique is not limited to single words, and the same technique could be used to align one entire utterance of multiple words with another entire utterance. However, the simple technique deliberately constrains the alignment to align the beginning of each utterance with the beginning of the other utterance and the end of each utterance with the end of the other utterance.

In one implementation of the first embodiment, the dynamic time alignment matches the two utterances allowing an arbitrary starting time and an arbitrary ending time for the matched portion of each utterance. The following pseudo-code (A) shows one implementation of such a dynamic time alignment. The StdAcousticDist value in the pseudo-code is set at a value such that aligned frames that represent the same sound will usually have AcousticDistance(Data1[f1],Data2[f2]) values that are less than StdAcousticDist and frames that do not represent the same sound will usually have AcousticDistance values that are greater than StdAcousticDist. The value of StdAcousticDist is empirically adjusted by testing various values for StdAcousticDist on practice data (hand-labeled, if necessary).

The formula for Rating(f1,f2) is a measure of the degree of acoustic match between the portion of Utterance1 from Start1 (f1,f2) to f1 with the portion of utterance2 from Start2(f1,f2) to f2. The formula for Rating(f1,f2) is designed to have the following properties:

1) For portions of the same length, a lower average value of AcousticDistance across the portions gives a better Rating;

2) The match of longer portions is preferred over the match of shorter portions (that would otherwise have an equivalent Rating) if the average AcousticDistance value on the extra portion is better than StdAcousticDist.

Other choices for a Rating function may be used instead of the particular formula given in this particular pseudo-code implementation. In one implementation of the first embodiment, the Rating function has the two properties mentioned above or at least qualitatively similar properties.

(A) Pseudo-code for one implementation of modified dynamic-time-alignment

```
  for all frames f of second utterance {
  alpha(0,f) = f2 * StdAcousticDist:
  Start2(0,f) = f;
  }
  for all frames f1 of first utterance
    alpha(f1,0) = f1 * StdAcousticDist;
    Start1(f1,0) = f1;
    for all frames f2 of second utterance
      Score = AcousticDistance(Data1[f1],Data2[f2]);
      Stay1Score = alpha(f1,f2−1) + StayPenalty + Score;
      PassScore = alpha(f1−1,f2−1) + PassPenalty + 2 * Score;
        // This implementation of dynamic-time alignment aligns two
instances with each other and is different from aligning a model to an
instance. The instances are treated symmetrically and the acoustic
distance score is weighted double on the the path that follows
the PassScore.//
      Stay2Score = alpha(f1−1,f2) + StayPenalty + Score;
      alpha(f1,f2) = Stay1Score;
      back(f1,f2) = (0,−1);
      Start1(f1,f2) = Start1(f1,f2−1);
      Start2(f1,f2) = Start2(f1,f2−1);
      if (PassScore<alpha(f1,f2)) {
        alpha(f1,f2) = PassScore;
        back(f1,f2) = (−1,−1);
        Start1(f1,f2) = Start1(f1−1,f2−1);
        Start2(f1,f2) = Start2(f1−1,f2−1);
      }
      if (Stay2Score<alpha(f1,f2)) {
        alpha(f1,f2) = Stay2Score;
        back(f1,f2) = (−1,0);
        Start1(f1,f2) = Start2(f1−1,f2);
        Start2(f1,f2) = Start1(f1−1,f2);
      }
      Len(f1,f2) = f1 − Start1(f1,f2) + f2 − Start2(f1,f2);
      Rating(f1,f2) = StdAcousticDist * Len(f1,f2) − alpha(f1,f2);
      if (Rating(f1,f2) > BestRating) {
        BestRating = Rating(f1 ,f2);
        BestF1 = f1;
        BestF2 = f2;
      }
    }
  }
  BestStart1 = Start1(BestF1,BestF2);
  BestStart2 = Start2(BestF1,BestF2);
  Compare BestRating with selection criterion, if selected then {
    the selected portion from utterance1 is from BestStart1 to BestF1;
    the selected portion from utterance2 is from BestStart2 to BestF2;
    the acoustic match score is BestRating;
  }
```

Referring again to FIG. 2, block 240 tests the degree of similarity of the two portions with a selection criterion. In the example implementation illustrated in the pseudo-code (A) above is the Rating(f1,f2) function. The rating for the selected portions is BestRating. In one implementation of the first embodiment, the preliminary selection criterion BestRating>0 is used. A more conservative threshold BestRating>MinSelectionRating may be determined by balancing the trade-off between missed selections and false alarms. The trade-off would be adjusted depending on the relative cost of missed selections versus false alarms for a particular application. The value of MinSelectionRating may be adjusted based on a set of practice data using formula (1)

CostOfMissed*(NumberMatchesDetected(x))/x=CostOfFalseDetection*(NumberOfFalseAlarms(x))/x (1)

The value of x which satisfies formula (1) is selected as MinSelectionRating. If no value of x>0 satisfies formula (1), then MinSelectionRating=0 is used. Generally the left-hand side of formula (1) will be greater than the right-hand side at x=0. However, since there are only a limited number of correct matches, eventually as the value of x is increased, the left-hand side of (1) will be reduced and the right-hand side will become as large as the left-hand side. Then formula (1) would be satisfied and the corresponding value of x would be used for MinSelectionRating.

Block 250 creates a common pattern template. The following pseudo-code (B) can be executed following pseudo-code (A) to traceback the best scoring path, in order to find the actual frame-by-frame alignment that resulted in the BestRating score in pseudo-code (A):

(B) Pseudo-code for one implementation of tracing back in time alignment

```
f1 = BestF1;
f2 = BestF2;
Beg1 = Start1(f1,f2);
Beg2 = Start2(f2,f2);
while (f1>Beg1 or f2>Beg2) {
  record point <f1,f2> as being on the alignment path
  <f1,f2> = <f1,f2> + Back(f1,f2);
}
```

The traceback computation finds a path through the two-dimensional array of frame times for utterance 1 and utterance 2. The point <f1,f2> is on the path if frame f1 of utterance 1 is aligned with frame f2 of utterance 2. Block 250 creates a common pattern template in which each node or state in the template corresponds to one or more of the points <f1,f2> along the path found in the traceback There are several implementations for choosing the number of nodes in the template and choosing which points <f1,f2> are associated with each node of the template. One implementation chooses one of the two utterances as a base and has one node for each frame is the selected portion of the chosen utterance. The utterance may be chosen arbitrarily between the two utterances, or the choice could always be the shorter utterance or always be the longer utterance. One implementation of the first embodiment maintains the symmetry between the two utterances by having the number of nodes in the template be the average of the number of frames in the two selected portions. Then, if pair <f1,f2> is on the traceback path, it is associated with node

node=(f1−Beg1+f2−Beg2)/2.

Each node is associated with at least one pair <f1,f2> and therefore is associated with at least one data frame from utterance 1 and at least one data frame from utterance 2. In one implementation of the first embodiment, each node in the common pattern template is associated with a model for the Data frames as a multivariate Gaussian distribution with a diagonal covariance matrix. The mean and variance of each Gaussian variable for a given node is estimated by standard statistical procedures.

Block 260 checks whether more utterance pairs are to be compared and more common pattern templates created.

FIG. 3 shows the process for updating a common pattern template to represent more acoustically similar utterances portions beyond the pair used in FIG. 2, according to the first embodiment.

Blocks 210, 220, 230, 240, and 250 are the same as in FIG. 2. As illustrated in FIG. 3, more utterances are compared to see if there are additional acoustically similar portions that can be included in the common pattern template.

Block 310 selects an additional utterance to compare.

Block 320 matches the additional utterance against the common pattern template. Various matching methods may be used, but one implementation of the first embodiment models the common pattern template as a hidden Markov process and computes the probability of this hidden Markov process generating the acoustic data observed for a portion of this utterance using the Gaussian distributions that have been associated with its nodes. This acoustic match computation uses a dynamic programming procedure that is a version of the forward pass of the forward-backward algorithm and is well-known to those skilled in the art of speech recognition. One implementation of this procedure is illustrated in pseudo-code (C).

(C) Pseudo-code for matching a (linear node sequence) hidden Markov model against a portion of an utterance

```
alpha(0,0) = 0.0;
for every frame f of utterance {
  alpha(0,f) = alpha(0,f−1) + StdScore;
  for every node n of the model {
    PassScore = alpha(n−1,f−1) + PassLogProb;
    StayScore = alpha(n,f−1) + StayLogProb;
    SkipScore = alpha(n−2,f−1) + SkipLogProb;
    alpha(n,f) = StayScore;
    Back(n,f) = 0;
    if (PassScore>alpha(n,f)) {
      alpha(n,f) = PassScore;
      Back(n,f) = −1;
    }
    if (SkipScore>alpha(n,f)) {
      alpha(n,f) = SkipScore;
      Back(n,f) = −2;
    }
    alpha(n,f) = alpha(n,f) + LogProb(Data(f),Gaussian(n));
  }
  Rating(f) = alpha(N,f) − StdRating * f;
  if (Rating(f)>BestRating) {
    BestEndFrame = f;
    BestRating = Rating(f);
  }
}
// traceback
n = N;
f = BestEndFrame;
while (n>0) {
  Record <n,f> as on the alignment path
  n = n + Back(n,f);
  f = f−1;
}
```

The matching in the pseudo-code (C) implementation of Block 320, unlike the matching in FIG. 2, is not symmetric. Rather than matching two utterances, it is matching a template with a Gaussian model associated with each node against a template.

Block 330 compares the degree of match between the model and the best matching portion of the given utterance with a selection threshold. For the implementation example in pseudo-code (C), the score BestRating is compared with zero, or some other threshold determined empirically from practice data.

If the best matching portion matches better than the criterion, then block 340 updates the common template. In one implementation of the first embodiment exemplified by pseudo-code (C), each frame in the additional utterance is aligned to a particular node of the common pattern template. A node may be skipped, or several frames may be assigned to a single node. The data for all of the frames, if any, assigned to a given node are added to the training Data vectors for the multivariate Gaussian distribution associated with the node and the Gaussian distributions are re-estimated. This creates an updated common pattern template that is based on all the utterance portions that have been aligned with the given template.

Block 340 checks to see if there are more utterances to be compared with the given common pattern template. If so, control is returned to block 310.

If not, control goes to block 360, which checks if there are more common pattern templates to be processed. If so, control is returned to block 220. If not, the processing is done, as indicated by block 370.

In some applications, there will be thousands (or even hundreds of thousands) of conversations, with common phrases that are used over and over again in many conversations, because the conversations (or dialogues) are all on the same narrow subject. These repeated phrases become common pattern templates, and block 330 finds many utterance portions to select as matching each common pattern template. As an increasing number of selected portions are selected as matching a given common pattern template and are used to update the models in the template, the more accurate the template becomes. Thus the template can become very accurate, even though the actual words in the phrase associated with the template have not yet been identified at this point in the process. In other applications, there may be only a moderate number of conversations and a moderate number of repetitions of any one common phrase.

There are also other possible embodiments that compare and combine more than two utterance portions by extending the procedure illustrated in FIG. 2 rather than using the process illustrated in FIG. 3. A second embodiment simply uses the mean values (and ignores the variances) for the Gaussian variables as Data vectors and treats the common pattern template as one of the two utterances for the procedure of FIG. 2. A third embodiment, which better maintains the symmetry between the two Data sequences being matched, first combines two or more pairs of normal utterance portions to create two or more common pattern templates (for utterance portions that are all acoustically similar). Then a common pattern templates may be aligned and combined by treating each of them as one of the utterances in the procedure of FIG. 2.

After all the utterance portions matching well against a given common pattern template have been found, the process illustrated in FIG. 4 recognizes the word sequence associated with these utterance portion.

Referring to FIG. 4, block 410 obtains a set of acoustically similar utterance portions. For example, all the utterances that match a given common pattern template better than a specified threshold may be selected. The process in FIG. 4 uses the fact that the same phrase has been repeated many times to recognize the phrase more reliably than could be done with a single instance of the phrase. However, to recognize multiple instances of the same unknown phrase simultaneously, special modifications must be made to the recognition process. Two leading word sequence search methods for recognition of continuous speech with a large vocabulary are frame-synchronous beam search and a multi-stack decoder (or a priority queue search sorted first by frame time then by score).

The concept of a frame-synchronous beam search requires the acoustic observations to be a single sequence of acoustic data frames against which the dynamic programming matches are synchronized. Since the acoustically similar utterances portions will generally have varying durations, an extra step is required before the concept of being “frame-synchronous” can have any meaning.

In one possible implementation of this embodiment, each of the selected utterance portions is replaced by a sequence of data frames aligned one-to-one with the nodes of the common pattern template. The data pseudo-frames in this alignment are created from the data frames that were aligned to each node in the matching computation in block 320 of FIG. 3. If several frames are aligned to a single node in the match in block 320, then these frames are replaced by a single frame that is the average of the original frames. If a node is skipped in the alignment, then a new frame is created that is the average of the last frame aligned with an earlier node and the nest frame that is aligned with a later node. If a single frame is aligned with the node, which will usually be the most frequent situation, then that frame is used by itself.

The process described in the previous paragraph produces a dynamic time aligned copy of each selected utterance portion with the same number of pseudo-frames for each of them. Conceptually the Data vectors for an entire set of corresponding frames, one from each utterance portion, can be treated as a single extremely long vector. Equivalently, the probability of each frame Data observation in the combined pseudo-frame is the product of the probabilities of frame Data observations for the corresponding frame in each of the selected utterance portions. Using this combined probability model as the probability for each frame, the collection of utterances may be recognized using either a pseudo-frame-synchronous beam search or a multi-stack decoder (with the time aligned pseudo-frame as the stack index).

A fourth embodiment is shown in more detail in FIG. 4. There is extra flexibility in this implementation, since the optimum alignment to the model is recomputed for each selected utterance portion. As explained above, the concept of a frame-synchronous search has no meaning in this case, so this implementation uses a priority queue search.

Referring again to FIG. 4 for this implementation, block 420 begins the priority queue search or multi-stack decoder by making the empty sequence the only entry in the queue.

Block 430 takes the top hypothesis on the priority queue and selects a word as the next word to extend the top hypothesis by adding the selected word to the end of the word sequence in the top hypothesis. At first the top (and only) entry in the priority queue is the empty sequence. In the first round, block 430 selects words as the first word in the word sequence. In one implementation of the fourth embodiment, if there is a large active vocabulary, there will be a fast match prefiltering step and the word selections of block 430 will be limited to the word candidates that pass the fast match prefiltering threshold.

Fast match prefiltering on a single utterance is well-known to those skilled in the art of speech recognition (see Jelinek, pgs. 103-109). One implementation of fast match prefiltering for block 430 is to perform conventional prefiltering on a single selected utterance portion. Another implementation, which requires more computation for the prefiltering, but is more accurate, performs fast match independently on a plurality of the utterance portions in the selected set. For each word, its fast match scores for each of the plurality of utterance portions is computed and the scores are averaged. If the word is not on the prefilter list for one of the utterance portions, its substitute score for that utterance portion is taken to be the worst of the scores of the words on the prefilter list plus a penalty for not being on the list. The scores (or penalized substitute scores) are averaged. The words are rank ordered according to the average scores and a prefiltering threshold is set for the combined scores.

Block 440 computes the match score for the top hypothesis extended by the selected word using the dynamic programming acoustic match computation that is well-known to those skilled in the art of speech recognition and stack decoders. One implementation is shown in pseudo-code (D).

(D) Pseudo-code for matching the extension w of hypothesis H for all frames f starting at EndTime(H)

```
{
  for all nodes n of model for word w {
    StayScore = alpha(n,f−1) + StayLogProb;
    PassScore = alpha(n−1,f−1) + PassLogProb;
    SkipScore = alpha(n−2,f−1) + SkipLogProb;
    alpha(n,f) = StayScore;
    if (PassScore>alpha(n,f)) {
      alpha(n,f) = PassScore;
    }
    if (SkipScore>alpha(n,f)) {
      alpha(n,f) = SkipScore;
    }
    alpha(n,f) = alpha(n,f) + LogProb(Data(f),Gaussian(n))
      − Norm;
  }
  Stop when alpha(N,f) reaches a maximum and then drops back by
    an amount AlphaMargin;
  EndTime(<H,w>) is the f which maximizes alpha(n,f)
  Score(<H,w>) = alpha(N,EndTime(<H,w>))
    // This is the score for the extended hypothesis <H,w>
  // N is the last node of word w.
  // Norm is set so that, on practice data,
  // Norm = (AvgIn(LogProb(Data(f),Gaussian(N)))
    + AvgAfter(LogProb(Data(f),Gaussian(N)))) / 2;
  // where AvgIn() is taken over frames that align to node N and
  // AvgAfter() is taken over frames from the segment after the
  // end of word w.
}
```

The extended hypothesis <H,w> receives the score for this utterance of Score(<H,w>) and the ending time for this utterance of EndTime(<H,w>).

Block 450 checks to see if there are any more utterance portions to be processed in the acoustic match dynamic programming extension computation.

If not, in block 460 the values of Score(<H,w>) are averaged across all the given utterance portions, and in block 465 the extended hypothesis <H,w> is put into the priority queue with this average score.

Block 470 checks to see if all extensions <H,w> of H have been evaluated. Recall that in block 430 the selected values for word w were restricted by the fast match prefiltering computation.

Block 475 sorts the priority queue. As a version of the multi-stack search algorithm, one implementation of this embodiment sorts the priority queue first according to the ending time of the hypothesis. In one implementation of this embodiment, the ending time in this multiple utterance computation is taken as the average value of EndTime(<H,w>) averaged across the given utterance portions, rounded to the nearest integer. For two hypotheses with the same value for this rounded average ending time, they are sorted according to their scores, that is the average value of Score(<H,w>) averaged across the given utterance portions.

Block 480 checks to see if a stopping criterion is met. For this multiple utterance implementation of the multi-stack algorithm, the stopping criterion in one implementation of this embodiment is based on the values of EndTime(<H>) for the new top ranked hypothesis H. An example stopping criterion is that the average value of EndTime(<H>) across the given utterance portions is greater than or equal to the average ending frame time for the given utterance portions.

If the stopping criterion is not met, then the process returns to block 430 to select another hypothesis extension to evaluate. If the criterion is met, the process proceeds to block 490.

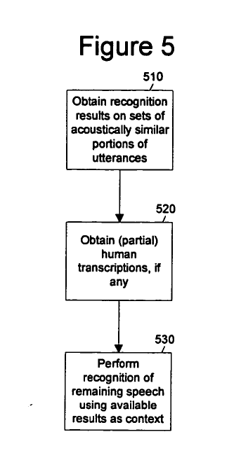

In block 490, the process of recognizing the repeated acoustically similar phrases is completed and the overall process continues by recognizing the remaining speech segments in each utterance, as illustrated in FIG. 5.

Referring to FIG. 5, block 510 obtains the results from the recognition of the acoustically similar portions, such as may have been done, for example, by the process illustrated in FIG. 4.

Block 520 obtains transcripts, if any, that are available from human transcription or from human error correction of speech recognition transcripts. Thus, both block 510 and block 520 obtain partial transcripts that are more reliable and accurate than ordinary unedited speech recognition transcripts of single utterances.

Block 530 then performs ordinary speech recognition of the remaining portion of each utterance. However, this recognition is based in part on using the partial transcriptions obtained in blocks 510 and 520 as context information. That is, for example, when the word immediately following a partial transcript is being recognized, the recognition system will have several words of context that have been more reliably recognized to help predict the words that will follow. Thus the overall accuracy of the speech recognition transcripts will be improved not only because the repeated phrases themselves will be recognized more accurately, but also because they provide more accurate context for recognizing the remaining words.

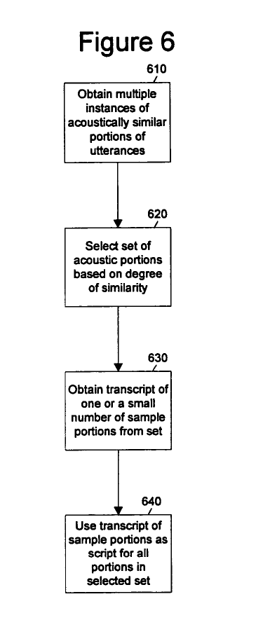

FIG. 6 describes an alternative implementation of one part of the process of recognizing acoustically similar phrases illustrated in FIG. 4. The alternative implementation shown in FIG. 6 provides a more efficient means to recognize repeated acoustically similar phrases when there are a large number of utterance portions that are all acoustically similar to each other.

As may be seen from the catalog order call center example that was described above, there are applications in which the same phrase may be repeated hundreds of thousands of times. Of course at first, without transcripts, the repeated phrase is not known and it is not known which calls contain the phrase.

Thus, referring to FIG. 6, the process starts by block 610 obtaining acoustically similar portions of utterances (without needing to know the underlying words).

Block 620 selects a smaller subset of the set of acoustically similar utterance portions. This smaller subset will be used to represent the large set. In this alternative implementation, the smaller subset will be selected based on acoustic similarity to each other and to the average of the larger set. For selecting the smaller subset, a tighter similarity criterion is than for selecting the larger set. The smaller subset may have only, say, a hundred instances of the acoustically similar utterance portion, while the larger set may have hundreds of thousands.

In other applications, there may be only a smaller number of conversations and only a few repetitions of each acoustically similar utterance portion. Then, in one version of this embodiment, a single representative sample (that is a one element subset) is selected. Even if there are only five or ten repeated instances of an acoustically similar utterance portion, it will save expense to select a single representative sample, especially if human transcription is to be used.

Block 630 obtains a transcript for the smaller set of utterance portions. It may be obtained, for example, by the recognition process illustrated in FIG. 4. Alternately, because a transcription is required for only one or a relatively small number of utterance portions, a transcription may be obtained from a human transcriptionist.

Block 640 uses the transcript from the representative sample of utterance portions as transcripts for all of the larger set of acoustically similar utterance portions. Processing may then continue with recognition of the remaining portions of the utterances, as shown in FIG. 5.

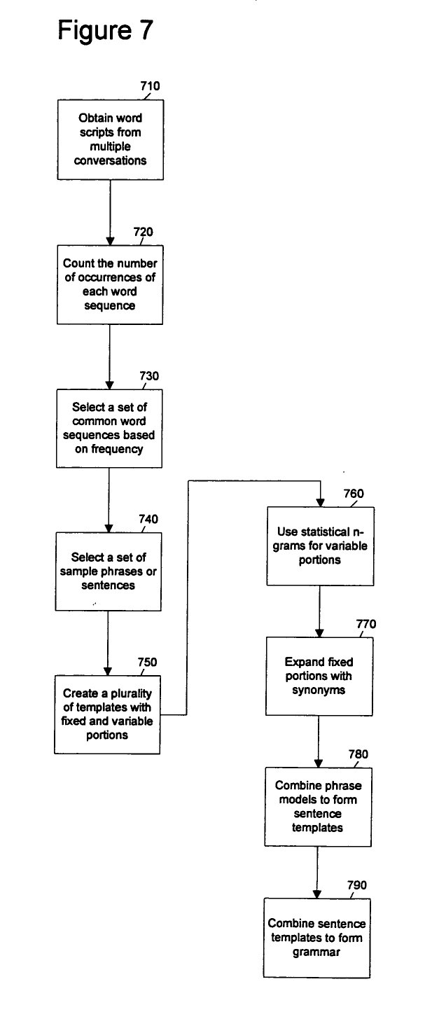

FIG. 7 describes a fifth embodiment of the present invention. In more detail, FIG. 7 illustrates the process of constructing phrase and sentence templates and grammars to aid the speech recognition.

Referring to FIG. 7, block 710 obtains word scripts from multiple conversations. The process illustrated in FIG. 7 only requires the scripts, not the audio data. The scripts can be obtained from any source or means available, such as the process illustrated in FIG. 5 and 6. In some applications, the scripts may be available as a by-product of some other task that required transcription of the conversations.

Block 720 counts the number of occurrences of each word sequence.

Block 730 selects a set of common word sequences based on frequency. In purpose, this is like the operation of finding repeated acoustically similar utterance portions, but in block 730 the word scripts and frequency counts are available, so choosing the common, repeated phrases is simply a matter of selection. For example, a frequency threshold could be set and the selected common word sequences would be all word sequences that occur more than the specified number of times.

Block 740 selects a set of sample phrases and sentences. For example, block 740 could select every sentence that contains at least one of the word sequences selected in block 730. Thus a selected sentence or phrase will contain some portions that constitute one or more of the selected common word sequences and some portions that contain other words.

Block 750 creates a plurality of templates. Each template is a sequence of pattern matching portions, which may be either fixed portions or variable portions. A word sequence is said to match a fixed portion of a template only if the word sequence exactly matches word-for-word the word sequence that is specified in the fixed portion of the template. A variable portion of a template may be a wildcard or may be a finite state grammar. Any word sequence is accepted as a match to a wildcard. A word sequence is said to match a finite state grammar portion if the word sequence can be generated by the grammar.

Since a fixed word sequence or a wildcard may also be represented as a finite grammar, each portion of a template, and the template as a whole may each be represented as a finite state grammar. However, for the purpose of identifying common, repeated phrases it is usefuil to distinguish fixed portions of templates. It is also useful to distinguish the concept of a wildcard, which is the simplest form of variable portion.

Block 760 creates a statistical n-gram language model. In one implementation of the fifth embodiment, each fixed portion is treated as a single unit (as if it were a single compound word) in computing n-gram statistics.

Block 770, which is optional, expands each fixed portion into a finite state grammar that represents alternate word sequences for expressing the same meaning as the given fixed portion by substituting synonymous words or sub-phrases for parts of the given fixed portion. If this step is to be performed, a dictionary of synonymous words and phrases would be prepared beforehand. By way of example and not by way of limitation, consider the example sentences given above for the automated personal assistant.

Suppose that on Friday, May 2, 2003 the user wants to check his or her appointment calendar for Tuesday, May 6, 2003. The following spoken commands are all equivalent:

a) “Show me May 6.”

b) “Display my calendar for Tuesday”

c) “Display next Tuesday”

d) “Get calendar for May 6, 2003”

e) “Show my appointments for four days from today”

f) Synonymous phrases include:

g) (Display, Show, Get, Show me, Get me)

h) (calendar, my calendar, appointments, my appointments)

i) (Tuesday, next Tuesday, May 6, May 6 2003, four days from today)

There are many variations that the user might speak for this command. An example of a grammar to represent many of these variations is as follows:

(Show (me), Display, Get (me), Go to) ((my) (calendar, appointments) for) ((Tuesday) May 6 (2003), (next) Tuesday, four days from (now, today)).

Block 780 combines the phrase models for fixed and variable portions to form sentence templates. In the example given above, the phrase models:

a) (Show (me), Display, Get (me), Go to)

b) ((my) (calendar, appointments) for)

c) ((Tuesday) May 6 (2003), (next) Tuesday, four days from (now, today))

are combined to create the sentence template for one sample sentence. To form a sentence, one example is taken for each constituent phrase.

Block 790 combines the sentence templates to form a grammar for the language. Under the grammar, a sentence is grammatical if and only if it matches an instance of one of the sentence templates.

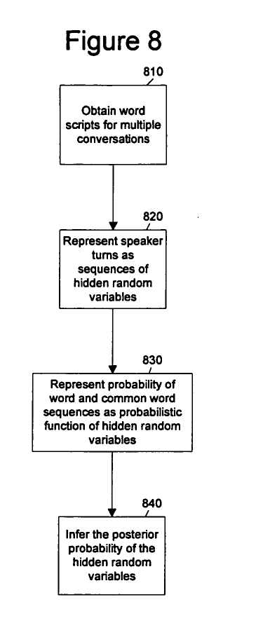

FIG. 8 illustrates a sixth embodiment of the invention. The conversations modeled by the sixth embodiment of the invention may be in the form of natural or artificial dialogues. Such a dialogue may be characterized by a set of distinct states in the sense that when the dialogue is in a particular state certain words, or phrase, or sentences may be more probable then they are in other states. In one implementation of the sixth embodiment, the dialogue states are hidden. That is, they are not specified beforehand, but must be inferred from the conversations. FIG. 8 illustrates the inference of the states of such a hidden state space dialogue model.

Referring to FIG. 8, block 810 obtains word scripts for multiple conversations. Such word scripts may be obtained, for example, by automatic speech recognition using the techniques illustrated in FIGS. 4, 5 and 6. Or such word scripts may be available because a number of conversations have already been transcribed for other purposes.

Block 820 represents each speaker turn as a sequence of hidden random variables. For example, each speaker turn may be represented as a hidden Markov process. The state sequence for a given speaker turn may be represented as a sequence X(0), X(1), . . . , X(N), where X(k) represents the hidden state of the Markov process when the k th word is spoken.

Block 830 represents the probability of word sequences and of common word sequence as a probabilistic function of the sequence of hidden random variables. For example, the probability of the k th word may be modeled as Pr(W(k)|X(k), W(k−1)). That is, by way of example and not by way of limitation, the conditional probability of each word bigram may be modeled as dependent on the state of the hidden Markov process.

Block 840 infers the a posteriori probability distribution for the hidden random variables, given the observed word script. For example, if the hidden random variables are modeled as a hidden Markov process, the posterior probability distributions may be inferred by the forward/backward algorithm, which is well-known to those skilled in the art of speech recognition (see Huang et. al., pp. 383-394).

FIG. 8 illustrates the inference of the hidden states of one or more particular dialogues. FIG. 9 illustrates the process of inference of a model for the set of dialogues.

Referring to FIG. 9, block 910 obtains word scripts for a plurality of conversations.

Block 920 represents the instance at which a switch in speaker turn occurs by the fact of the dialogue being in a particular hidden state. The same hidden state will occur in many different conversations, but it may occur at different times. The concept of dialogue “state” represents the fact that, depending on the state of the conversation, the speaker may be likely to say certain things and may be unlikely to say other things. For example, in the mail order call center application, when the call center operator asks the caller for his or her mailing address, the caller is likely to speak an address and is unlikely to speak a phone number. However, if the operator has just asked for a phone number, the probabilities will be reversed.

Block 930 represents each speaker turn as a transition from one dialogue state to another. That is, not only does the dialogue state affect the probabilities of what words will be spoken, as represented by block 920, but what a speaker says in a given speaker turn affects the probability of what dialogue state results at the end of the speaker turn. In the mail order call center application, for example, the dialogue might have progressed to a state in which the call center operator needs to know both the address and the phone number of the caller. The call center operator may choose to prompt for either piece of information first. The next state of the dialogue depends on which prompt the operator chooses to speak first.

Block 940 represents the probabilities of the word and common word sequences for a particular speaker turn as a function of the pair of dialogue states, that is, the dialogue state preceding the particular speaker turn and the dialogue state that results from the speaker turn. Statistics are accumulated together for all speaker turns in all conversations for which the pair of dialogue states is the same.

Block 950 infers the hidden variables and trains the statistical models, using the EM (expectation and maximize) algorithm, which is well-known to those skilled in the art of speech recognition (see Jelinek, pgs. 147-163).

(E) Pseudo code for inference of dialogue state model

```
Iterate n until model convergence criterion is met {
  For all conversations {
    For all words W(k) in conversation {
      For all hidden states s {
        alpha(k,s) = Sum( alpha(k−1,r)Pr[n](X(k)=s|X(k−1)=r)
          *Pr[n](W(k)|W(k−1),s));
      }
    }
    Initialize beta(N+1,s) = 1 / number of s=hidden states for all s;
    Backwards through all words W(k) [k decreasing] {
      For all hidden states s {
        beta(k,s) = Sum(beta(k+1,r)Pr[n](X(k+1)=r|X(k)=s)
          *Pr[n](W(k+1)|W(k),r));
      }
    }
    For all words W(k) in conversation {
      For all hidden states s {
        gamma(k,s) = alpha(k,s) * beta(k,s);
        WordCount(W(k),W(k−1),s) += gamma(k,s);
        For all hidden states r {
          TransCount(s,r) = TransCount(s,r)
            + alpha(k,s)*Pr[n](X(k+1)=r|X(k)=s)
            Pr[n](W(k+1)|W(k),r)*beta(k+1,r);
        }
      }
    }
  }
  For all words w1, w2 and all hidden states s {
    Pr[n+1](w1,w2,s) = WordCount(w1,w2,s)
      /Sum(w)(WordCount(w,w2,s));
  }
  For all hidden states s,r {
    Pr[n+1](X(k)=s|X(k−1)=r) = TransCount(s,r)
      /Sum(x)(TransCount(x,r));
  }
}
```

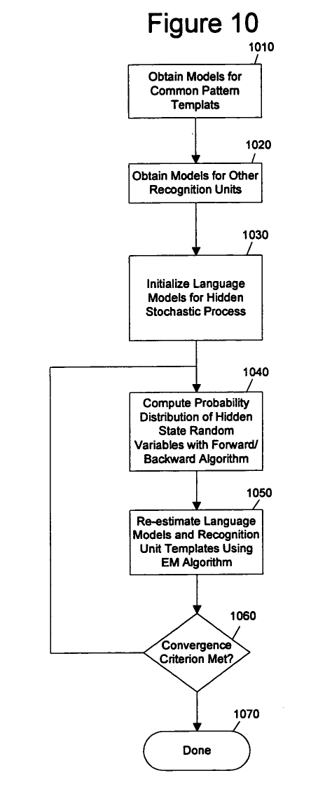

FIG. 10 illustrates a seventh embodiment of the invention. In the seventh embodiment of the invention, the common pattern templates may be used directly as the recognition units without it being necessary to transcribe the training conversations in terms of word transcripts. A recognition vocabulary is formed from the common pattern templates plus a set of additional recognition units. In one implementation of the seventh embodiment, the additional recognition units are selected to cover the space of acoustic patterns when combined with the set of common pattern templates. For example, the set of additional recognition units may be a set of word models from a large vocabulary speech recognition system. In one implementation of the seventh embodiment, the set of word models would be the subset of words in the large vocabulary speech recognition system that are not acoustically similar to any of common pattern templates. Alternately, the set of additional recognition units may be a set of “filler” models that are not transcribed as words, but are arbitrary templates merely chosen to fill out the space of acoustic patterns. If a set of such acoustic “filler” templates is not separately available, they may be created by the training process illustrated in FIG. 10, starting with arbitrary initial models.

Referring now to FIG. 10, a set of models for common pattern templates is obtained in block 1010, such as by the process illustrated in FIG. 3, for example.

A set of additional recognition units is obtained in block 1020. These additional recognition units may be models for words, or they may simply be arbitrary acoustic templates that do not necessary correspond to words. They may be obtained from an existing speech recognition system that has been trained separately from the process illustrated here. Alternately, models for arbitrary acoustic templates may be trained as a side effect of the process illustrated in FIG. 10. Under this alternate implementation of the seventh embodiment, it is not necessary to obtain a transcription of the words in the training conversations. Since a large call center may generate thousands of hours of recorded conversations per day, the cost of transcription would be prohibitive, so the ability to train without requiring transcription of the training data is one aspect of this invention. If the arbitrary acoustic templates are to be trained as just described, the models obtained in block 1020 are merely the initial models for the training process. These models may be generated essentially at random. In one implementation of the seventh embodiment, the initial models are chosen to give the training process what is called a “flat start”. That is, all the initial models for these additional recognition units are practically the same. In one implementation of the seventh embodiment, each initial model is a slight random perturbation from a neutral model that matches the average statistics of all the training data. Essentially any random perturbation will do, whereby it is merely necessary to make the models not quite identical so that the iterative training described below can train each model to a separate point in acoustic model space.

An initial statistical model for the sequences of recognition units is obtained in block 1030. When trained, this statistical model will be similar to the model trained as illustrated in FIGS. 7-9, except in the seventh embodiment as illustrated in FIG. 10, recognition units are used that are not necessarily words, and transcription of the training data is not required. An initial estimate for this statistical model of recognition unit sequences is only needed to be obtained in block 1030. In one implementation of the seventh embodiment, this initial model may be a flat start model with all sequences equally likely, or may be a model that has previously been trained on other data.

The probability distributions for the hidden state random variables are computed in block 1040. In one implementation of the seventh embodiment, the forward/backward algorithm, which is well-known for training acoustic models, although not generally used for training language models, is used in block 1040. Pseudo-code for the forward/backward algorithm is given in pseudo-code (F), provided below.

The models are re-estimated in block 1050 using the well-known EM algorithm, which has already been mentioned in reference to block 950 in FIG. 9. Pseudo-code for the preferred embodiment of the EM algorithm is given in pseudo-code (F).

Block 1060 checks to see if the EM algorithm has converged. The EM algorithm guarantees that the re-estimated models will always have a higher likelihood of generating the observed training data than the models from the previous iteration. When there is no longer a significant improvement in the likelihood of the observed training data, the EM algorithm is regarded as having converged and control passes to the termination block 1070. Otherwise the process returns to Block 1040 and uses the re-estimated models to again compute the hidden random variable probability distributions using the forward/backward algorithm.

(F) Pseudo code for training recognition units and hidden state dialog models

```
Iterate until model convergence criterion is met {
  // Forward/backward algorithm (Block 1040)
  For all conversations {
    Initialize alpha for time t=0;
    For all acoustic frames t in conversation {
      For all recognition units u {
        alpha(t,u,0) = Sum(alpha(t−1,u,Exit)
          *Pr(X(k)=u|X(k−1)=v));
        For all hidden states s internal to u {
          alpha(t,u,s) = (alpha(t−1,u,s)A(s|s,u)
            + alpha(t−1,u,s−1)A(s|s−1,u))
            *Pr(Acoustic at time t|s,u);
        }
      }
    }
    Initialize beta(N+1,u,Exit) = 1 / number of units for all u;
    Backwards through all acoustic frames t [t decreasing] {
      For all recognition units u {
        beta(t,u,Exit) = Sum(beta(t+1,v)Pr(X(t+1)=v|X(t)=u);
        For all hidden states s in u {
          temp(t+1,u,s) = beta(t+1,u,s)
            *Pr(Acoustic at time t|s,u);
        }
        For all hidden states s internal to u {
          beta(t,u,s) = temp(t+1,u,s)A(s|s,u)
            + temp(t+1,u,s+1)A(s+1|s,u);
        }
      }
    }
    For all acoustic frames t in conversation {
      For units u and all hidden states <u,s> going to <v,r> {
        gamma(t,u,s,v,r) = alpha(t,u,s) * beta(t+1,v,r)
          * TransProb(v,r|u,s);
          TransCount(u,s,v,r) = TransCount(u,s,v,r)
            + gamma(t,u,s,v,r);
        }
      }
    }
  }
  // EM algorithm re-estimation (Block 1050)
  For all hidden states s,r of all units u {
    A(s|r,u) = TransCount(s,r,u)
      / Sum(x)(TransCount(x,r,u));
  }
  For all unit u going to v {
    Pr(v|u) = TransCount(u,s,v,r)
      / Sum(x,y)(TransCount(x,u,y,v);
  }
  For all internal states s of all units u {
    Re-estimate sufficient statistics for Pr(Acoustic at time t|s,u);
      // For example, re-estimate means and covariances for
      // Gaussian distributions.
  }
  Compute product across all utterances of all
  conversations of alpha(U,T),
    where U is the designated utterance final unit
    and T is the last time frame;
  Stop the iterative process if there is no
  improvement from the previous iteration;
}
```

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A method of speech recognition, comprising:
obtaining acoustic data from a plurality of conversations;
selecting a plurality of pairs of utterances from said plurality of conversations;
dynamically aligning and computing acoustic similarity of at least one portion of the first utterance of said pair of utterances with at least one portion of the second utterance of said pair of utterances;
choosing at least one pair that includes a first portion from a first utterance and a second portion from a second utterance based on a criterion of acoustic similarity; and
creating a common pattern template from the first portion and the second portion.

2. The method of speech recognition according to claim 1, further comprising:
matching said common pattern template against at least one additional utterance from said plurality of conversations based on the acoustic similarity between said common pattern template and the dynamic alignment of said common pattern template to a portion of said additional utterance; and
updating said common pattern template to model the dynamically aligned portion of said additional utterance as well as said first portion from said first utterance and said second portion from said second utterance.

3. The method of speech recognition according to claim 2, further comprising:
performing word sequence recognition on the plurality of portions of utterances aligned to said common pattern template by recognizing said portions of utterances as multiple instances of the same phrase.

4. The method of speech recognition according to claim 3, further comprising:
creating a plurality of common pattern templates; and
performing word sequence recognition on each of said plurality of common pattern templates by recognizing the corresponding portions of utterances as multiple instances of the same phrase.

5. The method of speech recognition according to claim 4, further comprising:
performing word sequence recognition on the remaining portions of a plurality of utterances from said plurality of conversations.

6. The method of speech recognition according to claim 2, further comprising:
repeating the step of matching said common pattern template against a portion of an additional utterance for each utterance in a set of utterances to obtain a set of candidate portions of utterances;
selecting a plurality of portions of utterances based on the degree of acoustic match between said common pattern template and each given candidate portion of an utterance; and
obtaining transcriptions of said selected plurality of portions of utterances by obtaining a transcription for one of said plurality of portions of utterances.

7. The method of speech recognition according to claim 6, wherein the selecting step and the obtaining step are performed simultaneously.

8. The method of speech recognition according to claim 1, wherein said criterion of acoustic similarity is based in part on the acoustic similarity of aligned acoustic frames and in part on the number of frames in said first portion and in said second portion in which a pair of portions with more acoustic frames is preferred under the criterion to a pair of portions with fewer acoustic frames if both pairs of portions have the same average similarity per frame for the aligned acoustic frames.

9. A speech recognition grammar inference method, comprising:
obtaining word scripts for utterances from a plurality of conversations based at least in part on a speech recognition process;
counting a number of times that each word sequence occurs in the said word scripts;
creating a set of common word sequences based on the frequency of occurrence of each word sequence;
selecting a set of sample phrases from said word scripts including a plurality of word sequences from said set of common word sequences; and
creating a plurality of phrase templates from said set of sample phrases by using said fixed template portions to represent said common word sequences and variable template portions to represent other word sequences in said set of sample phrases.

10. The speech recognition grammar inference method according to claim 9, further comprising:
modeling said variable template portions with a statistical language model based at least in part on word n-gram frequency statistics.

11. The speech recognition grammar inference method according to claim 9, further comprising:
expanding said fixed template portions of said phrase templates by substituting synonyms and synonymous phrases.

12. A speech recognition dialogue state space inference method, comprising:
obtaining word scripts for utterances from a plurality of conversations based at least in part on a speech recognition process;
representing the process of each speaker speaking in turn in a given conversation as a sequence of hidden random variables;
representing the probability of occurrence of words and common word sequences as based on the values of the sequence of hidden random variables; and
inferring the probability distributions of the hidden random variables for each word script.

13. A speech recognition dialogue state space inference method according to claim 12, further comprising:
representing the status of a given conversation at the instant of a switch in speaking turn from one speaker to another by the value of a hidden state random variable which takes values in a finite set of states.

14. A speech recognition dialogue state space inference method according to claim 13, further comprising:
estimating the probability distribution of the state value of said hidden state random variable based on the words and common word sequence which occur in the preceding speaking turns.

15. A speech recognition dialogue state space inference method according to claim 13, further comprising:
estimating the probability distribution of the words and common word sequence during a given speaking turn as being determined by the pair of values of said hidden state random variable with the first element of the pair being the value of said hidden state random variable at a time immediately preceding the given speaking turn and the second element of the pair being the value of said hidden state random variable at a time immediately following the given speaking turn.

16. A speech recognition system, comprising:
means for obtaining acoustic data from a plurality of conversations;
means for selecting a plurality of pairs of utterances from said plurality of conversations;
means for dynamically aligning and computing acoustic similarity of at least one portion of the first utterance of said pair of utterances with at least one portion of the second utterance of said pair of utterances;
means for choosing at least one pair that includes a first portion from a first utterance and a second portion from a second utterance based on a criterion of acoustic similarity; and
means for creating a common pattern template from the first portion and the second portion.

17. The speech recognition system according to claim 16, further comprising:
means for matching said common pattern template against at least one additional utterance from said plurality of conversations based on the acoustic similarity between said common pattern template and the dynamic alignment of said common pattern template to a portion of said additional utterance; and
means for updating said common pattern template to model the dynamically aligned portion of said additional utterance as well as said first portion from said first utterance and said second portion from said second utterance.

18. The speech recognition system according to claim 17, further comprising:
means for performing word sequence recognition on the plurality of portions of utterances aligned to said common pattern template by recognizing said portions of utterances as multiple instances of the same phrase.

19. The speech recognition system according to claim 18, further comprising:
means for creating a plurality of common pattern templates; and
means for performing word sequence recognition on each of said plurality of common pattern templates by recognizing the corresponding portions of utterances as multiple instances of the same phrase.

20. The speech recognition system according to claim 19, further comprising:
means for performing word sequence recognition on the remaining portions of a plurality of utterances from said plurality of conversations.

21. The speech recognition system according to claim 17, further comprising:
means for repeating the step of matching said common pattern template against a portion of an additional utterance for each utterance in a set of utterances to obtain a set of candidate portions of utterances;
means for selecting a plurality of portions of utterances based on the degree of acoustic match between said common pattern template and each given candidate portion of an utterance; and
means for obtaining transcriptions of said selected plurality of portions of utterances by obtaining a transcription for one of said plurality of portions of utterances.

22. The speech recognition system according to claim 17, wherein said criterion of acoustic similarity is based in part on the acoustic similarity of aligned acoustic frames and in part on the number of frames in said first portion and in said second portion in which a pair of portions with more acoustic frames is preferred under the criterion to a pair of portions with fewer acoustic frames if both pairs of portions have the same average similarity per frame for the aligned acoustic frames.

23. A speech recognition grammar inference system, comprising:
means for obtaining word scripts for utterances from a plurality of conversations based at least in part on a speech recognition process;
means for counting a number of times that each word sequence occurs in the said word scripts;
means for creating a set of common word sequence based on the frequency of occurrence of each word sequence;
means for selecting a set of sample phrases from said word scripts including a plurality of word sequences from said set of common word sequences; and
means for creating a plurality of phrase templates from said set of samples phrases by using said fixed template portions to represent said common word sequences and variable template portions to represent other word sequences in said set of sample phrases.

24. The speech recognition grammar inference system according to claim 23, further comprising:
means for modeling said variable template portions with a statistical language model based at least in part on word n-gram frequency statistics.

25. The speech recognition grammar inference system according to claim 24, further comprising:
means for expanding said fixed template portions of said phrase templates by substituting synonyms and synonymous phrases.

26. A speech recognition dialogue state space inference system, comprising:
means for obtaining word script for utterances from a plurality of conversations based at least in part on a speech recognition process;
means for representing the process of each speaker speaking in turn in a given conversation as a sequence of hidden random variables;
means for representing the probability of occurrence of words and common word sequences as based on the values of the sequence of hidden random variables; and
means for inferring the probability distributions of the hidden random variables for each word script.

27. A speech recognition dialogue state space inference system according to claim 26, further comprising:
means for representing the status of a given conversation at the instant of a switch in speaking turn from one speaker to another by the value of a hidden state random variable which takes values in a finite set of states.

28. A speech recognition dialogue state space inference system according to claim 27, further comprising:
means for estimating the probability distribution of the state value of said hidden state random variable based on the words and common word sequence which occur in the preceding speaking turns.

29. A speech recognition dialogue state space inference system according to claim 27, further comprising:
means for estimating the probability distribution of the words and common word sequence during a given speaking turn as being determined by the pair of values of said hidden state random variable with the first element of the pair being the value of said hidden state random variable at a time immediately preceding the given speaking turn and the second element of the pair being the value of said hidden state random variable at a time immediately following the given speaking turn.

30. A program product having machine-readable program code for performing speech recognition, the program code, when executed, causing a machine to perform the following steps:
obtaining acoustic data from a plurality of conversations;
selecting a plurality of pairs of utterances from said plurality of conversations;
dynamically aligning and computing acoustic similarity of at least one portion of the first utterance of said pair of utterances with at least one portion of the second utterance of said pair of utterances;
choosing at least one pair that includes a first portion from a first utterance and a second portion from a second utterance based on a criterion of acoustic similarity; and
creating a common pattern template from the first portion and the second portion.

31. The program product according to claim 30, further comprising:
matching said common pattern template against at least one additional utterance from said plurality of conversations based on the acoustic similarity between said common pattern template and the dynamic alignment of said common pattern template to a portion of said additional utterance; and
updating said common pattern template to model the dynamically aligned portion of said additional utterance as well as said first portion from said first utterance and said second portion from said second utterance.

32. The program product according to claim 31, further comprising:
performing word sequence recognition on the plurality of portions of utterances aligned to said common pattern template by recognizing said portions of utterances as multiple instances of the same phrase.

33. The program product according to claim 31, further comprising:
creating a plurality of common pattern templates; and
performing word sequence recognition on each of said plurality of common pattern templates by recognizing the corresponding portions of utterances as multiple instances of the same phrase.

34. The program product according to claim 33, further comprising:
performing word sequence recognition on the remaining portions of a plurality of utterances from said plurality of conversations.

35. A method of training recognition units and language models for speech recognition, comprising:
obtaining models for common pattern templates for a plurality of types of recognition units;
initializing language models for hidden stochastic processes;
computing probability distribution of hidden state random variables of the hidden stochastic processes representing hidden language model states according to a first predetermined algorithm;
estimating the language models and the models for the common pattern templates for the plurality of types of recognition units using a second predetermined algorithm; and
determining if a convergence criteria has been met for the estimating step, and if so, outputting the language models and the models for the common pattern templates for the plurality of types of recognition units, as an optimized set of models for use in speech recognition.

36. The method according to claim 35, wherein the first predetermined algorithm is a forward/backward algorithm, and
wherein the second predetermined algorithm is an expectation and maximize (EM) algorithm.
